(19) United States
(12) Patent Application Publication
(10) Pub. No.: US 2026/0314758 A1
(43) Pub. Date: Oct. 15, 2026

(54) IMPROVED BUCKLE AND STRAP

(71) Applicant: Ninefold Design LLC, Sacramento, CA (US)

(72) Inventor: Seth Russell Heltsley, Oakland, CA (US)

(73) Assignee: Ninefold Design LLC, Sacramento, CA (US)

(21) Appl. No.: 19/558,171

(22) Filed: Mar. 5, 2026

Related U.S. Application Data
(60) Provisional application No. 63/786,136, filed on Apr. 9, 2025.

(51) Int. Cl. A44B 11/12

(52) U.S. Cl. CPC A44B 11/125

(57) ABSTRACT

A buckle which utilizes a strap and a buckle receiving body such that excess slack may be easily removed when the buckle is not engaged with the buckle receiving body and that when the buckle is seated in the device body and subsequently rotated to a closed position, a desired amount of tension is present to secure a target object.

### CROSS-REFERNCE TO RELATED APPLICATIONS

This application claims priority to U.S. Provisional Application No. 63/768,136 filed Mar. 6, 2025, which is incorporated by reference in its entirety for all purposes.

### BACKGROUND

Securing two objects together is often achieved by using a strap and buckle combination. The strap is fed through the buckle and the buckle may be tightened using various means. For example, the strap may be provisioned with teeth and the buckle may include some ratcheting mechanism, such that as each successive tooth is fed through the buckle using the ratchet mechanism, the buckle provides some securing force to prevent the strap from loosening. However, in such a toothed/ratcheting configuration, the securing force is essentially quantized by the force supplied at each successive tooth, and a desired securing force may lie between the teeth on the straps. Further, feeding the strap through the buckle using the ratchet mechanism may require substantial amounts of force that are difficult for a user of the buckle.

### SUMMARY

Described herein is a buckle which is utilized to secure two objects. In one example, the buckle includes a body with a pivoting end and an effort end. The body has a hollow strap receiving section with two sidewalls and pivot arms located near the pivoting end. A lateral post is also located near the pivoting end and extends across the two sidewalls. A medial post is located between the lateral post and the effort end and extends across the two sidewalls. The pivot arms are adapted to rest inside a receiving socket on a device and the buckle is adapted to receive a strap with a load and a free end, so that when the load end of the strap is wrapped around the medial post, the free end can be threaded between the lateral post and the load end of the strap. When the pivot arm is resting inside the receiving socket and the buckle is in an open position, the pivoting end is adapted to permit removing of slack from the strap by application of a pulling force on the free end, and when the pivot arm is resting inside the socket and the buckle is in a closed position, the pivoting end is adapted to prevent movement of the strap.

### BRIEF DESCRIPTION OF THE DRAWINGS

To ensure that the claims will be readily understood, a more particular description of the examples briefly described above will be rendered by reference to specific examples illustrated in the appended drawings. Understanding that these drawings depict only typical examples and are not to be considered to be limiting in scope, the examples will be described and explained with additional specificity and detail through the use of the accompanying drawings, in which:

FIG. 1 depicts a perspective view of an example of a buckle consistent with this disclosure.

FIG. 2 depicts a side view of an example of a buckle, strap, and socket consistent with this disclosure.

FIG. 3 depicts an additional side view of an example of a buckle, strap, and socket consistent with this disclosure.

FIG. 4 depicts an additional side view of an example of a buckle, strap, and socket consistent with this disclosure.

FIG. 5 depicts an additional side view of an example of a buckle, strap, and socket consistent with this disclosure.

FIG. 6 depicts a perspective view of an example buckle, strap, and socket consistent with this disclosure.

FIG. 7 depicts a perspective view of an example buckle, strap, and socket in an open position consistent with this disclosure.

FIG. 8 depicts a perspective view of an example buckle, strap, and socket in an open position consistent with this disclosure.

### DETAILED DESCRIPTION

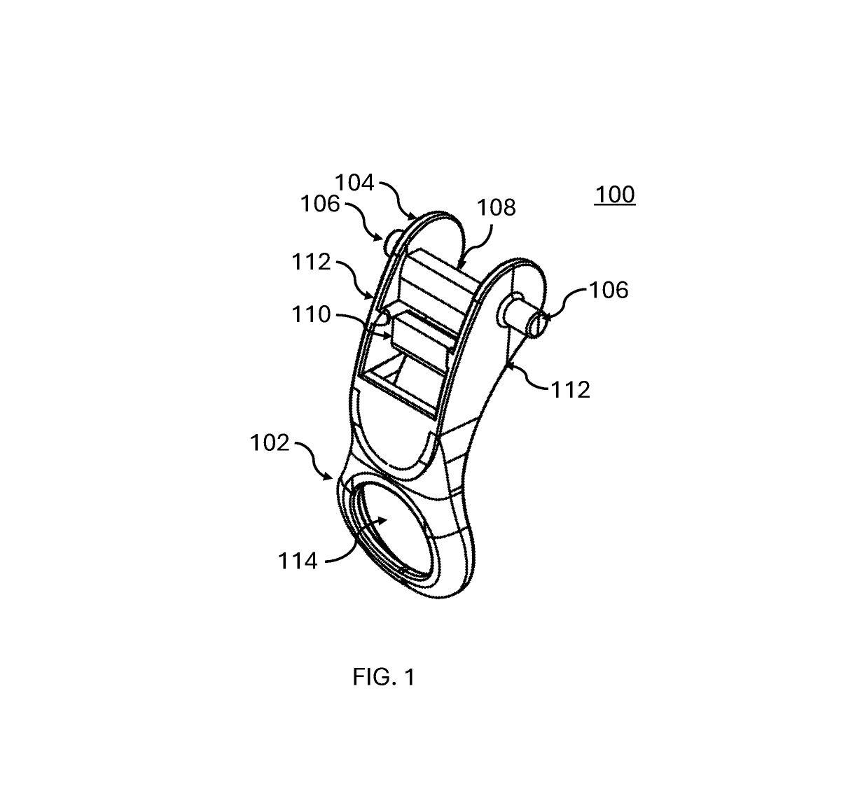

As shown in FIG. 1, buckle 100 includes effort end 102 and curved pivoting end 104. Pivot arms 106 are located near curved pivoting end 104. The body of buckle 100 is hollow near curved pivoting end 104 to allow for a space where a strap may be inserted. Lateral post 108 is located near curved pivoting end 104 and extends across the hollow portion of the buckle body, between sidewalls 112. Medial post 110 also extends across the hollow portion of the buckle body, between sidewalls 112. Although curved pivoting end 104 is depicted as curved in FIG. 1, the end of buckle 100 need not be curved.

As will be apparent from additional figures, curved pivoting end 104 and pivot arms 106 are disposed so that pivot arms 106 may rest in a socket. A strap may be inserted through the hollow portion of buckle 100 such that the load end of the strap wraps around medial post 110 and the free end of the strap is threaded between lateral post 108 and the load end of the strap. Although pivot arms 106 are depicted on buckle 100 so that buckle 100 is inserted into a socket, in an alternative embodiment, not shown here, buckle 100 may include sockets which are configured to attach to pivot arms on a device, so that buckle 100 rotates in the same manner as described herein.

As depicted in FIG. 1, effort end 102 of buckle 100 may include handle 114. Handle 114 is sized appropriately to allow a user to insert a finger (or other levering mechanism) through the handle aperture and thus more easily apply a releasing force (to cause buckle 100 to pivot around pivot arms 106) or a pulling force to assist in allowing the buckle to slide relative to an inserted strap.

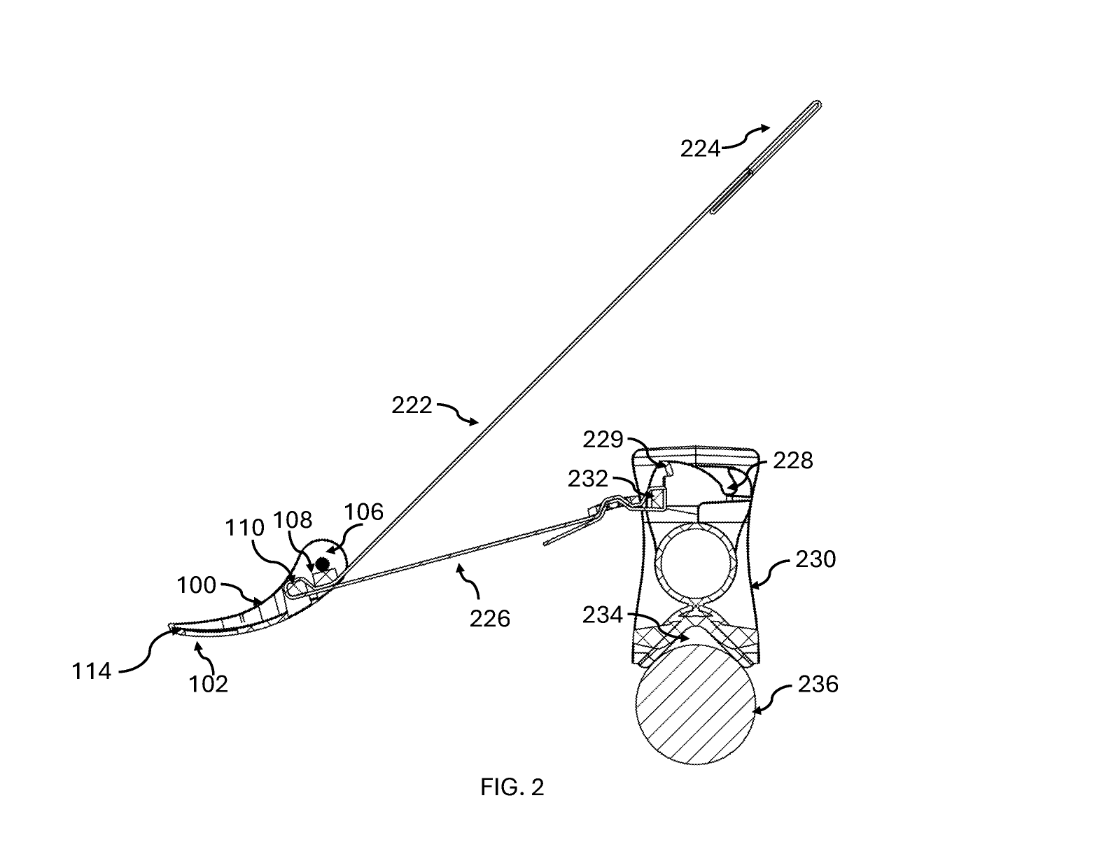

As shown in FIG. 2, buckle 100 is depicted with strap 222. Strap 222 includes free end 224 and load end 226. Load end 226 is anchored to device body 230 at anchor point 232. An object to be secured, such as cylindrical object 236 is seated in groove 234, although not securely attached to device body 230. Although an angled groove is depicted, other geometries may be utilized to ensure a more secure connection between a device body (which, in the embodiment depicted in this FIG. 2, contains the sockets) and the target object to be secured. Although cylindrical object 236 is depicted here in FIG. 2, other object shapes are possible. For example, a rectangular handle of a massage gun may be secured using improved buckle 100 by seating the rectangular handle of the massage gun in groove 234. Further, while sockets are shown here as part of device body 230, in an alternative embodiment, sockets may be placed on buckle 100 and hinge/pivot posts may be disposed on device 230, allowing sockets of buckle 100 to snap on to hinge/pivot posts of device body 230.

As discussed above with reference to FIG. 1, strap 222 is threaded through buckle 100. Specifically, load end 226 is wrapped around medial post 110 and free end 224 is threaded between load end 226 and lateral post 108. Pivot arms 106 extend outwardly from the body of buckle 100 and are sized so that pivot arms 106 may seat securely into socket 228. As depicted in FIG. 2, socket 228 provides a snap fit with pivots arms 106, although it is possible to allow for a less secure fit if desired. By providing a snap fit, buckle 100 is less likely to fall out of socket 228 while a user performs tensioning of buckle 100. Although only a single socket 228 is shown in this view of FIG. 2, device body 230 includes two sockets to receive both pivot arms 106.

In one example, buckle 100 is made of a stiff plastic such as glass fiber reinforced nylon, although other materials may be used. As depicted, the buckle is approximately 80 mm long and 40 mm wide, with an approximate thickness of 25 mm.

Pulling on handle 114 aligns the tension in the strap 222 relative to the orientation of buckle 100. When strap 222 is aligned around medial post 110 and the tension of the strap is not pinching free end 224, strap 222 slides through buckle 100 easily when a user pulls on handle 114 toward effort end 102. It should be noted that while cylindrical object 236 is shown as a cylinder, the disclosed buckle and strap may be used to secure objects of various geometries.

In one example, strap 222 is made of Nylon, although other materials may be used. As depicted in FIG. 2, strap 222 is 20 mm wide and 1.25 mm thick.

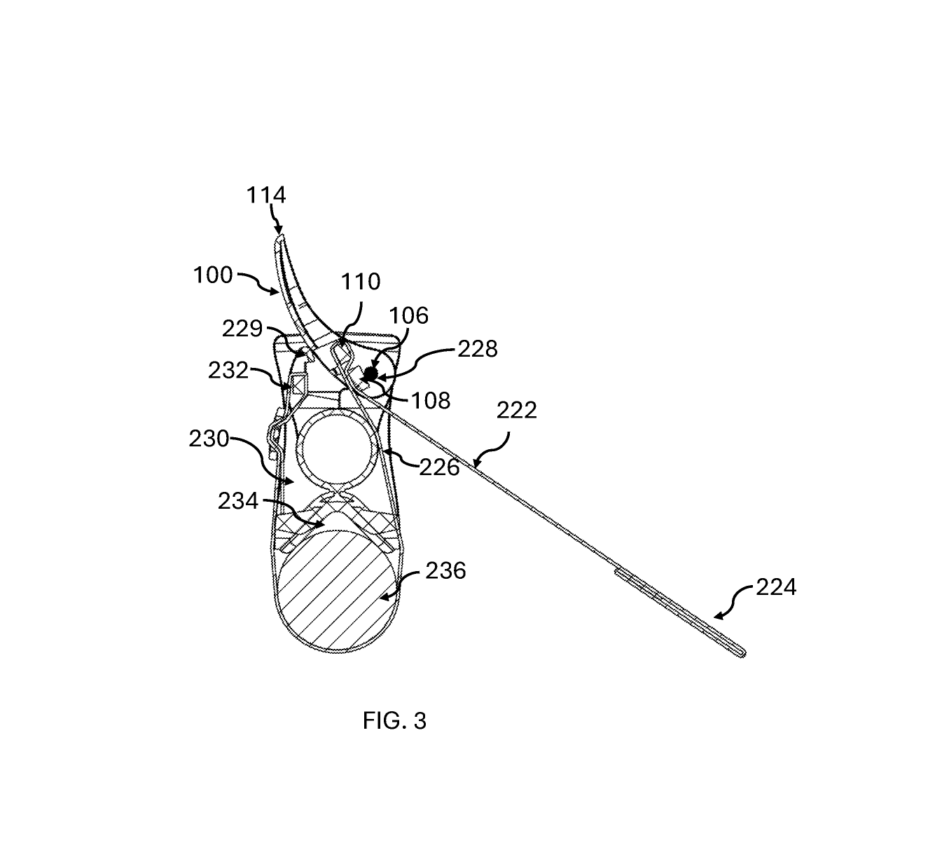

As shown in FIG. 3, buckle 100 has been attached to device body 230 by inserting pivot arms 106 into socket 228 and is situated in a fully open position. Cylindrical object 236 is now held loosely in place against device body 230 in groove 234. Strap 222 remains attached to anchor point 232 and load end 226 wraps around cylindrical object 236, then around medial post 110. Free end 224 is threaded between load end 226 and lateral post 108.

With buckle 100 clipped into its pivot point (i.e. socket 228), the relative angle of strap tension to buckle orientation allows strap 222 to slide. Free end 224 can be pulled to take up any slack in the enclosed loop of strap 222 around cylindrical object 236, thus further securing cylindrical object 236. Medial post 110 and lateral post 108 are aligned in FIG. 3 so that once a user removes slack by pulling on free end 224, there is sufficient friction to prevent a complete loss of tension when the user stops pulling on free end 224 – the strap will still roughly hold the object 236. Shoulder 229 limits rotation of buckle 100 and causes buckle 100 to stop at an angle which provides a desired amount of tension that may be used to secure cylindrical object 236. Adjusting the placement of shoulder 229 to cause buckle 100 to rest at a different angle will increase or decrease the amount of friction present in this fully open position, which in turn alters the amount of tension that the buckle is able to hold to temporarily to secure cylindrical object 236 while the buckle remains in the open position. This configuration is additionally designed to set the tension that will be used once the buckle is closed – a rotation of the buckle from the fully open position to the closed position will add tension corresponding to the rotation of the buckle from the fully open position to the closed position. A user could add additional tension by pulling on free end 224 while closing the buckle.

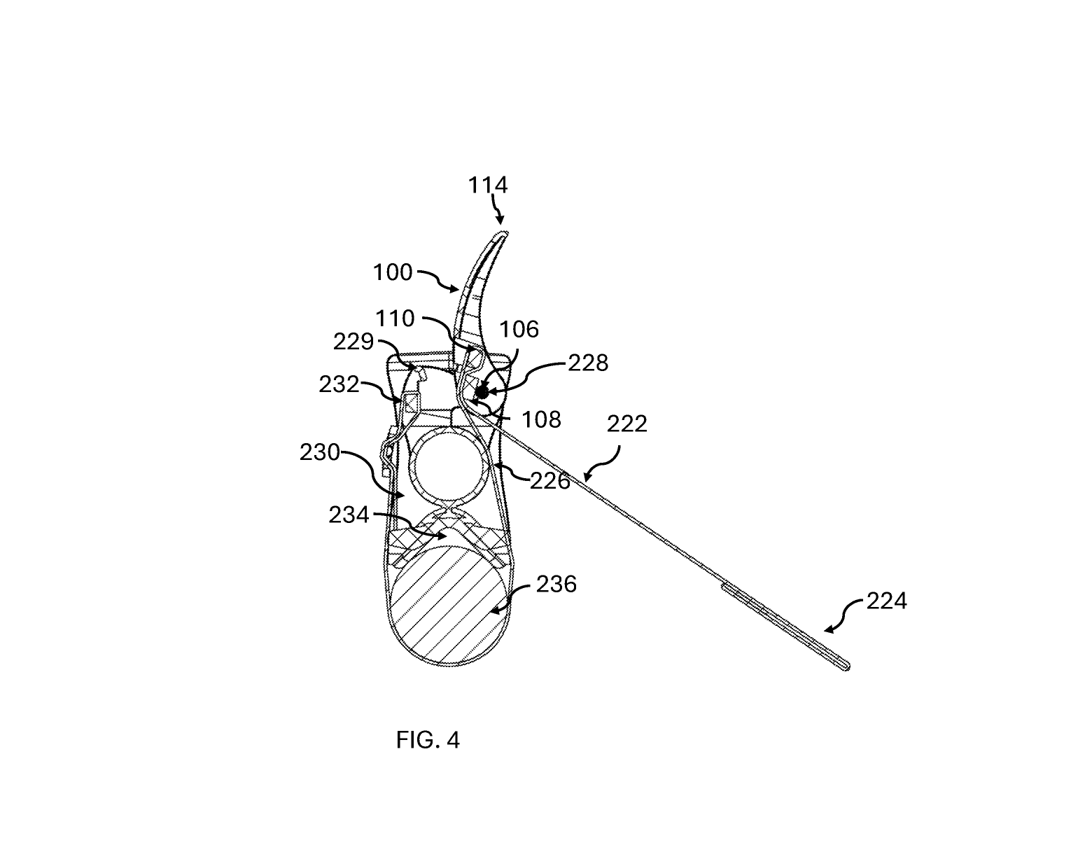

As shown in FIG. 4, buckle 100 has been attached to device body 230 by inserting pivot arms 106 into socket 228 and is now situated in a partially closed position after pivoting slightly from the fully open position of FIG. 3. Cylindrical object 236 is now held more securely (relative to FIG. 3) in place against device body 230 in groove 234. Strap 222 remains attached to anchor point 232 and load end 226 wraps around cylindrical object 236, then around medial post 110. Free end 224 is threaded between load end 226 and lateral post 108.

As buckle 100 starts to rotate around its pivot point at socket 228, strap 222 tension pinches free end 224 causing buckle 100 to lock strap 222 from feeding through. As buckle 100 continues to rotate it wraps more of strap 222 around buckle 100, increasing the tension in the enclosed loop around cylindrical object 236.

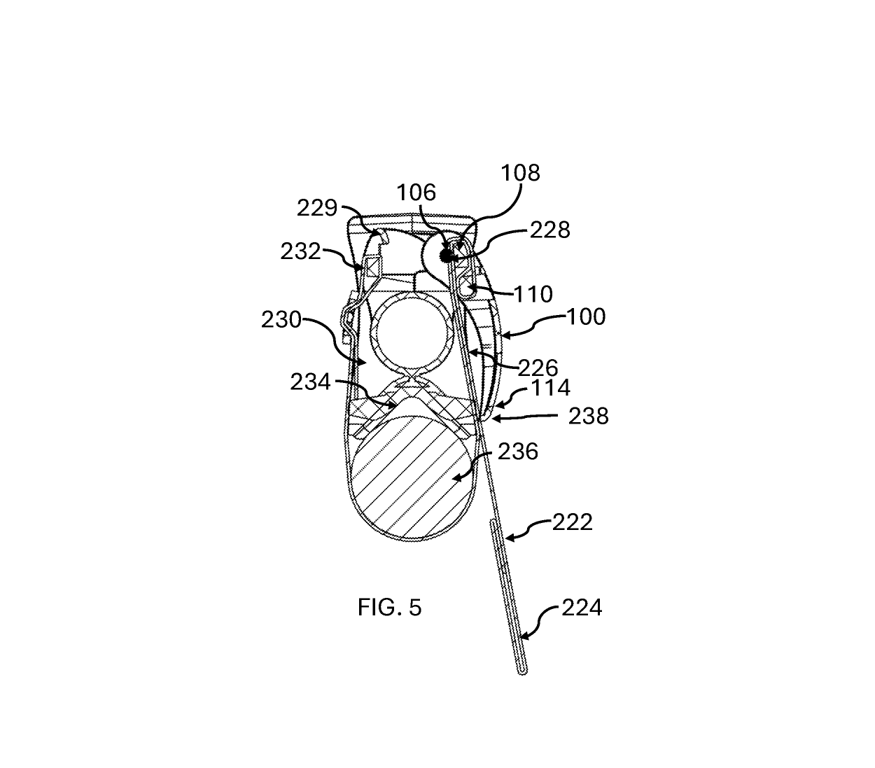

As shown in FIG. 5, buckle 100 has been attached to device body 230 by inserting pivot arms 106 into socket 228 and is now situated in a fully closed position after pivoting from the fully open position of FIG. 3. Cylindrical object 236 is now held securely in place against device body 230 in groove 234. Strap 222 remains attached to anchor point 232 and load end 226 wraps around cylindrical object 236, then around medial post 110. Free end 224 is threaded between load end 226 and lateral post 108.

Continuing the rotation of buckle 100 around its pivot point (at socket 228), strap tension increases. Near the end of the buckle’s rotation, the point of contact of the strap under tension moves from one side of the pivot point to the other, reversing the torque on buckle 100. As depicted in FIG. 5, buckle 100 is now in a closed position and the tension in strap 222 now holds the buckle in place. The placement of pivot arms relative to the posts and the location of the sockets allows for an over-center latch to occur. Thus, optimal placement of the arms and sockets may depend slightly on the particular application of device 230 and a target object to be secured. As shown in FIG. 5, movement of buckle 100 has been arrested by contact point 238. Contact point 238 provides a closing angle of the buckle to provide the desired final tension of strap 222 around cylindrical object 236. In some embodiments, contact point 238 may be on cylindrical object 236.

In moving from the open position to the ultimate closed position, buckle 100 increases tension on the load through multiple mechanisms. First, the geometry of lateral post 108 provides a surface that causes the load end of the strap to wrap around lateral post 108. When buckle 100 rotates, the geometry pulls more strap 222 in contact with the post, increasing tension. Second, the rotation of medial post 110 relative to the pivot axis results in a translation of the location of medial post 110 relative to the direction of the load end of the strap. This translation means there is an increased distance, thus causing increased tension. In an alternative embodiment, the medial post 110 and lateral post 108 may be connected and manufactured as a freely moving part within the structure of buckle 100. Medial post 110 and lateral post 108 may be adjustable within buckle 100 while maintaining their relative distance to one another. In such an arrangement the posts are able to be released to slide relative to the pivot access and then be locked in place. By translating toward the load in the unclamped state, they would take up more tension when the buckle is clamped because at that point they would be farther away from the load after the buckle is rotated around the pivot access from the unclamped to clamped position.

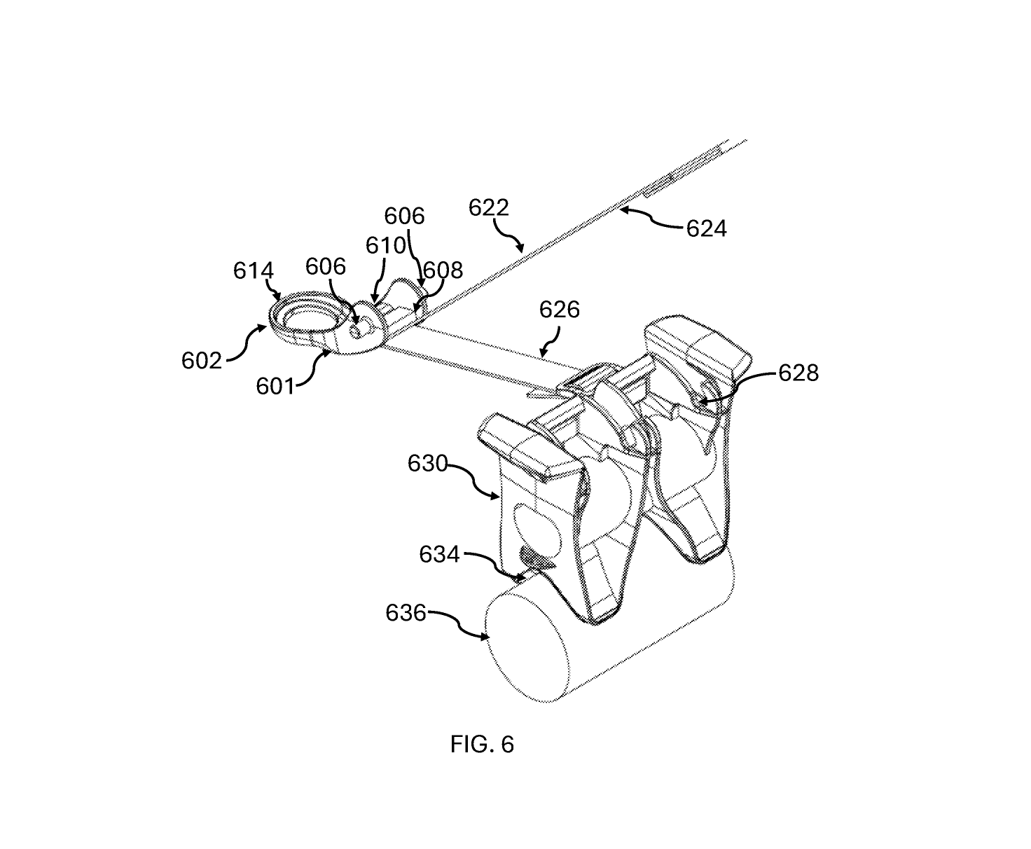

FIG. 6 depicts a perspective view of an exemplary buckle and strap attached to a device and configured to secure a cylinder. As shown in FIG. 6, buckle 601 is depicted with strap 622. Strap 622 includes free end 624 and load end 626. Load end 626 is anchored to device body 630 at an anchor point (not shown). Cylindrical object 636 is seated in groove 634, although not securely attached to device body 630.

Strap 622 is threaded through buckle 601. Specifically, load end 626 is wrapped around medial post 610 and free end 624 is threaded between load end 626 and lateral post 608. Pivot arms 606 extend outwardly from the body of buckle 601 and are sized so that pivot arms 106 may seat securely into socket 628.

Pulling on handle 614 aligns the tension in the strap 622 relative to the orientation of buckle 601. When strap 622 is aligned around medial post 610 and the tension of the strap is not pinching free end 624, strap 622 slides through buckle 601 easily when a user pulls on handle 614 toward effort end 602. It should be noted that while cylindrical object 236 is shown as a cylinder, the disclosed buckle and strap may be used to secure objects of various geometries.

As depicted in FIG. 6, device body 630 provides structure to hold two buckles to allow for a more secure clamping force on cylindrical object 636. Groove 634 additionally provides further assistance to prevent cylindrical object 636 from moving.

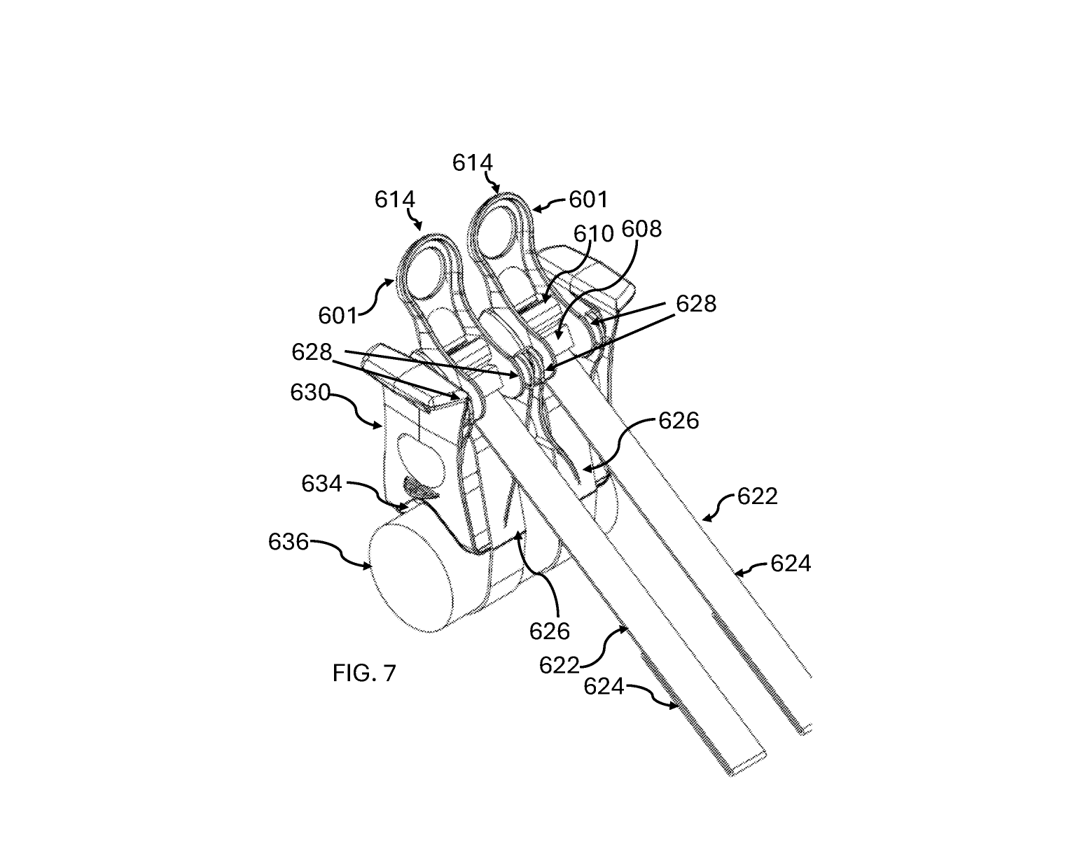

FIG. 7 depicts a perspective view of a pair of exemplary buckles and straps attached to a device and configured to secure a cylinder. As shown in FIG. 7, buckles 601 have been attached to device body 630 by inserting pivot arms (not labeled) into sockets 628 and are situated in a fully open position. Cylindrical object 236 is now held loosely in place against device body 630 in groove 634. Straps 622 remain attached to anchor points (not shown) and load ends 626 wrap around cylindrical object 636, then around medial post 610 on their respective buckles. Free ends 624 are threaded between load end 626 and lateral post 608.

With buckles 601 clipped into their respective pivot points (i.e. sockets 228), the relative angle of strap tension to buckle orientation allows straps 622 to slide. Free ends 624 can be pulled to take up any slack in the enclosed loop of straps 622 around cylindrical object 636, thus further securing cylindrical object 636. Again, although a cylindrical object is depicted, objects of different geometries may be secured utilizing the buckles of this disclosure.

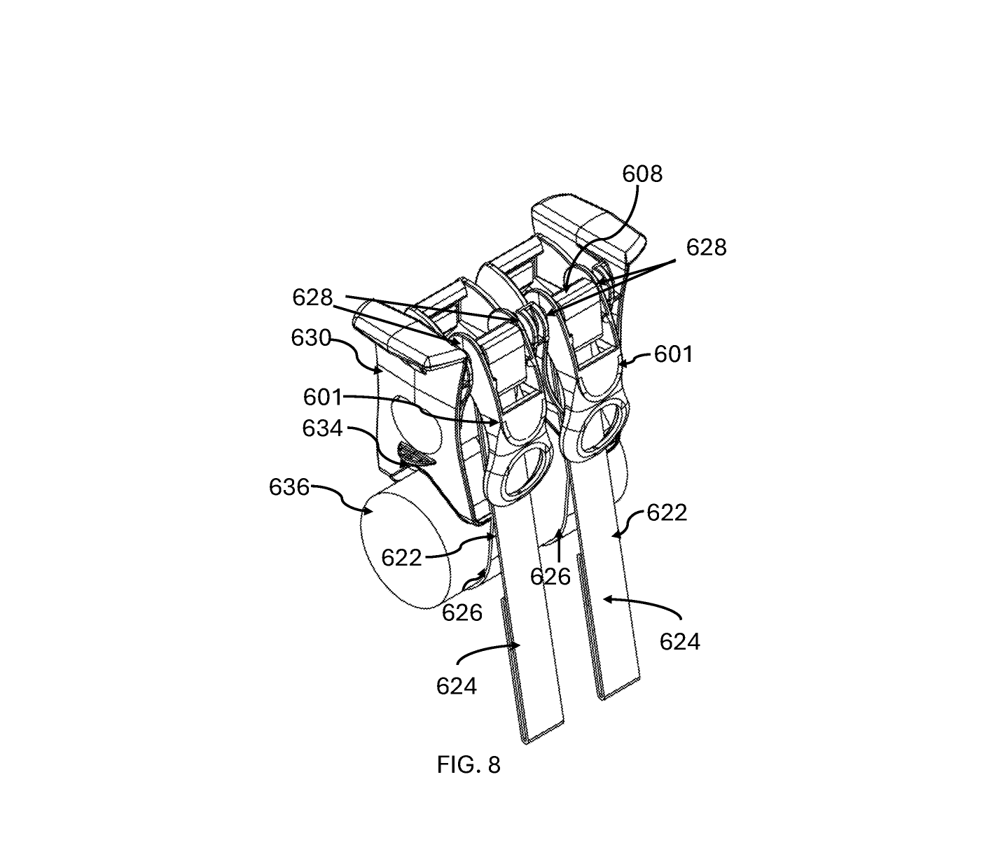

FIG. 8 depicts a perspective view of a pair of exemplary buckles and straps attached to a device and configured to secure a cylinder. As shown in FIG. 8, buckles 601 has been attached to device body 630 by inserting pivot arms into sockets 628 and is now situated in a fully closed position after pivoting from the fully open position of FIG. 7. Cylindrical object 636 is now held securely in place against device body 630 in groove 634. Straps 622 remain attached to anchor points and load ends 626 wrap around cylindrical object 636, then around medial posts on their respective buckles. Free end 624 is threaded between load end 626 and lateral post 608.

Continuing the rotation of buckles 601 around their pivot points (at sockets 628), strap tension increases. Near the end of the buckle’s rotation, the point of contact of the strap under tension moves from one side of the pivot point to the other, reversing the torque on buckle 601. As depicted in FIG. 8, buckles 601 are now in a closed position and the tension in straps 622 now hold the buckles in place.

The foregoing detailed description has been given for clearness of understanding only, and no unnecessary limitation should be understood therefrom. While the present invention has been described with reference to preferred embodiments and several alternative embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention therefore shall be defined solely by the claims. Further, it will be apparent to those of skill in the art that numerous changes may be made in such details without departing from the spirit and the principles of the invention. It should be appreciated that the present invention is capable of being embodied in other forms without departing from its essential characteristics.

What is claimed is:

1. A buckle comprising:
a body with a pivoting end and an effort end, the body comprising a hollow strap receiving section with two sidewalls;
a pivot arm, extending outward from the body, the pivot arm disposed near the pivoting end;
a lateral post disposed near the pivoting end and extending between the two sidewalls;
a medial post disposed between the lateral post and the effort end and extending between the two sidewalls;
wherein the pivot arm is adapted rest inside a socket;
wherein the buckle is adapted to receive a strap with a load end and a free end, so that when the load end of the strap is wrapped around the medial post, the free end is threaded between the lateral post and the load end of the strap; and
wherein, when the pivot arm is resting inside the socket and the buckle is in an open position, the pivoting end is adapted to permit removing of slack from the strap by application of a pulling force on the free end, and when the pivot arm is resting inside the socket and the buckle is in a closed position, the pivoting end is adapted to prevent movement of the strap.

2. The buckle of claim 1, wherein the socket is disposed on a device body, the device body further comprising a shoulder disposed to provide a resting position for the open position.

3. The buckle of claim 2, wherein the device body further comprises a contact point which arrests rotation of the buckle at the closed position.

4. The buckle of claim 2, wherein the device body is configured to hold an object and wherein the object comprises a contact point which arrests rotation of the buckle at the closed position.

5. The buckle of claim 2, wherein the device body further comprises a groove to receive an object to be secured by the strap.

6. A device comprising:
at least one socket wherein the socket is configured to receive a buckle, wherein the buckle comprises a body with a pivoting end and an effort end, the body further comprising a hollow strap receiving section with two sidewalls;
a pivot arm, extending outward from the body, the pivot arm disposed near the pivoting end;
a lateral post disposed near the pivoting end and extending between the two sidewalls;
a medial post disposed between the lateral post and the effort end and extending between the two sidewalls;
wherein the pivot arm is adapted rest inside the socket;
wherein the buckle is adapted to receive a strap with a load end and a free end, so that when the load end of the strap is wrapped around the medial post, the free end is threaded between the lateral post and the load end of the strap; and
wherein, when the pivot arm is resting inside the socket and the buckle is in an open position, the pivoting end is adapted to permit removing of slack from the strap by application of a pulling force on the free end, and when the pivot arm is resting inside the socket the buckle is in a closed position, the pivoting end is adapted to prevent movement of the strap.

7. The device of claim 6, the device further comprising a shoulder disposed to define a desired angle for the buckle to rest in the open position.

8. The device of claim 7, wherein the device body further comprises a contact point which arrests rotation of the buckle at the closed position.

9. The device of claim 7, the device further comprising an object to be secured by the device, wherein the object comprises a contact point which arrests rotation of the buckle at the closed position.

10. The device of claim 6, wherein the device further comprises a groove to receive an object to be secured by the strap.

11. A buckle comprising:
a body with a pivoting end and an effort end, the body comprising a hollow strap receiving section with two sidewalls;
a socket, disposed near the pivoting end;
a lateral post disposed near the pivoting end and extending between the two sidewalls;
a medial post disposed between the lateral post and the effort end and extending between the two sidewalls;
wherein the socket is adapted to be secured to a pivot arm;
wherein the buckle is adapted to receive a strap with a load end and a free end, so that when the load end of the strap is wrapped around the medial post, the free end is threaded between the lateral post and the load end of the strap; and
wherein, when the pivot arm is resting inside the socket and the buckle is in an open position, the pivoting end is adapted to permit removing of slack from the strap by application of a pulling force on the free end, and when the pivot arm is resting inside the socket and the buckle is in a closed position, the pivoting end is adapted to prevent movement of the strap.

12. The buckle of claim 11, wherein the pivot arm is disposed on a device body, the device body further comprising a shoulder disposed to provide a resting position for the open position.

13. The buckle of claim 12, wherein the device body further comprises a contact point which arrests rotation of the buckle at the closed position.

14. The buckle of claim 12, wherein the device body is configured to hold an object and wherein the object comprises a contact point which arrests rotation of the buckle at the closed position.

15. The buckle of claim 12, wherein the device body further comprises a groove to receive an object to be secured by the strap.
